(19) United States
(12) Patent Application Publication
(10) Pub. No.: US 2011/0185564 A1
(43) Pub. Date: Aug. 4, 2011

(54) Method for Fixing an Annular Segment Package Having a Cylindrical Outer Wall in An Annular Housing

(75) Inventors: Markus Ploch, Bad Soden (DE); Hans-Dieter Wilhelm, Darmstadt (DE)

(73) Assignee: Continental Automotive GmbH, Hannover (DE)

(21) Appl. No.: 12/682,433

(22) PCT Filed: Oct. 6, 2008
(86) PCT No.: PCT/EP2008/063321

§ 371 Date: Jul. 13, 2010

(30) Foreign Application Priority Data
Oct. 10, 2007 (DE) 10 2007 048 499.4

(51) Int. Cl. H02K 15/00

(52) U.S. Cl. 29/596

(57) ABSTRACT

An annular housing has an inner wall that is configured in the form of an inner cone. In the method for fixing the annular segment package, said package is either initially inserted into the annular housing and an annular sleeve the outer wall of which is configured in the form of an outer cone that is configured in a compatible manner to the inner cone of the annular housing, is subsequently inserted between the annular segment package and the annular housing and compressed on both sides, or is initially inserted into the annular sleeve and compressed, and the annular sleeve is subsequently inserted into the annular housing together with the annular segment package and compressed.

### PRIORITY CLAIM

This is a U.S. national stage of application No. PCT/EP2008/063321, filed on 6 Oct. 2008. which claims priority to the German Application No.: 10 2007 048 499.4, filed: 10 Oct. 2007; the content of which is incorporated here by reference.

### BACKGROUND OF THE INVENTION

1. Field of the Invention

The invention relates to a method for fixing an annular segment package with a cylindrical outer wall in an annular housing.

2. Prior Art

Annular segment packages are known. They operate in different areas and must be assembled in advance from their individual segments before installation in the annular housings. Like the annular housings in which the annular segment packages are intended to be fixed, such annular segment packages are generally composed of metallic materials. In practice, the housings are in this case heated for fixing, and thus expand. The annular segment packages are then introduced into the respective annular housings, and each combination is then cooled. The cooling effect results in the housing contracting, which leads to the annular segment package being fixed firmly in the annular housing by compression. However, this procedure has the disadvantage that the annular housing must be heated homogeneously, which is often not easy to do. During the final cooling process, different force effects often occur on the annular segment packages, which is likewise undesirable in many cases.

### SUMMARY OF THE INVENTION

The invention is therefore based on providing a method for fixing an annular segment package with a cylindrical outer wall in an annular housing that be carried out with relatively few problems and simply, avoiding the different disadvantageous force effects on the annular segment package.

According to one embodiment of the invention, the method for fixing an annular segment package with a cylindrical outer wall in an annular housing, whose inner wall is in the form of an inner cone, in which the annular segment package is either first of all introduced into the annular housing and then an annular sleeve, whose outer wall is in the form of an outer cone which is designed to be compatible with the inner cone of the annular housing, is introduced between the annular segment package and the annular housing and is compressed on both sides, or it is first of all introduced into the annular sleeve and is compressed, and the annular sleeve is then introduced into the annular housing, together with the annular segment package, and is compressed.

The compression of the annular segment package in the annular sleeve ensures that the annular sleeve has a cylindrical inner wall whose diameter corresponds virtually to the diameter of the cylindrical outer wall of the annular segment package. In engineering terms, the respective internal diameter or external diameter are in this case chosen such that the annular segment package is introduced into the annular sleeve by an appropriate force effect, and is compressed by a force fit. The annular sleeve is compressed in a similar manner in the annular housing. The inner cone of the annular housing is in this case designed to be compatible with the outer cone formed on the annular sleeve, such that the annular sleeve is introduced into the annular housing by an appropriate force effect, and is compressed by an interlock. Both the annular sleeve and the annular housing are in this case preferably composed of metallic materials, although this is not absolutely essential. Surprisingly, it has been found that the annular segment package can be fixed in the annular housing in a relatively simple, unproblematic manner, when the corresponding annular sleeve is compressed between the annular segment package and the annular housing, in which case it is possible to completely dispense with the disadvantageous heating of the annular housing. The corresponding mutually compatible configuration of the inner cone and outer cone in this case ensures that the annular segment package has forces applied to it uniformly, seen over its circumference, during the fixing process, thus making it possible to avoid damage to the annular segment package caused by widely differing force effects.

Two alternatively technically equivalent process methods are feasible for carrying out the method. According to the first method, the annular segment package is first of all introduced into the annular housing, and the annular sleeve is then compressed between the annular segment package and the annular housing, on both sides. According to the second method, provision is made for the annular segment package to first of all be introduced into the annular sleeve, and to be compressed with it. The combination of the annular segment package and the annular sleeve is then introduced into the annular housing, and is compressed with it. The second method is particularly advantageous when initial assembly is envisaged. Which method is chosen differs from case to case, and is governed, for example, by the customer's wish.

One preferred embodiment of the invention provides that a common angle γ for the inner cone and for the outer cone is chosen in the range from 2 to 5°. This ensures good compression of the annular sleeve between the annular segment package and the annular housing, and this is particularly suitable for many purposes.

According to a further preferred embodiment of the invention, an annular sleeve is used which, starting from the outer edge with the smallest external diameter of the outer cone, has longitudinal slots arranged alongside one another parallel to the longitudinal axis of the annular sleeve and whose respective length l is less than the width of the annular sleeve. The arrangement of the longitudinal slots allows tolerances during the fixing process to be compensated for relatively easily and advantageously, thus simplifying the respective compression process.

According to a further embodiment of the invention, the length l of the respective longitudinal slots is chosen to be greater than the width b of the annular segment package.

This optimizes the compression process, and makes it easier to fix the annular segment package in the annular housing.

According to one embodiment of the invention, the annular sleeve is arranged with its outer edge having the smallest external diameter of the outer cone resting on a stop, in the state in which it is compressed in the annular housing. In this case it is particularly advantageous for the stop itself to be a part of the annular housing. This results in the annular sleeve being seated particularly well in the annular housing, thus optimally fixing the annular segment package.

According to one embodiment of the invention, an annular stator laminated core of an electric motor is arranged as the annular segment package, and a stator housing of an electric motor is arranged as the annular housing. To make it easier to arrange the stator windings, it has been found to be particularly advantageous for the stator for an electric motor to be a package of individual stator laminate units. Each stator laminate unit in this case contains a portion of the windings, which together then form the overall stator winding. When the annular stator laminated core is being fixed in the stator housing, it can be particularly advantageous to avoid the need to heat the stator housing. The method allows particularly advantageous fixing of the annular stator laminated core in the stator housing, in which case it is possible to entirely dispense with the disadvantageous heating of the stator housing as a preparatory measure.

According to one embodiment of the invention, an electric motor for a hybrid car is the electric motor. In general, electric motors for hybrid cars are subject to stringent requirements. These also include the need to fix the annular segment package, which is then in the form of an annular stator laminated core, particularly well in the stator housing. The method complies with the stringent requirements in a particularly advantageous and simple manner.

### BRIEF DESCRIPTION OF DRAWINGS

The invention will be explained in more detail and by way of example in the following text with reference to the drawing.

FIG. 1 is a perspective view of the arrangement of the annular segment package, of the annular housing and of the annular sleeve, in the form of an exploded drawing; and

FIG. 2 is the annular housing and the annular sleeve in the compressed state, in the form of a longitudinal section.

### DETAILED DESCRIPTION OF THE DRAWINGS

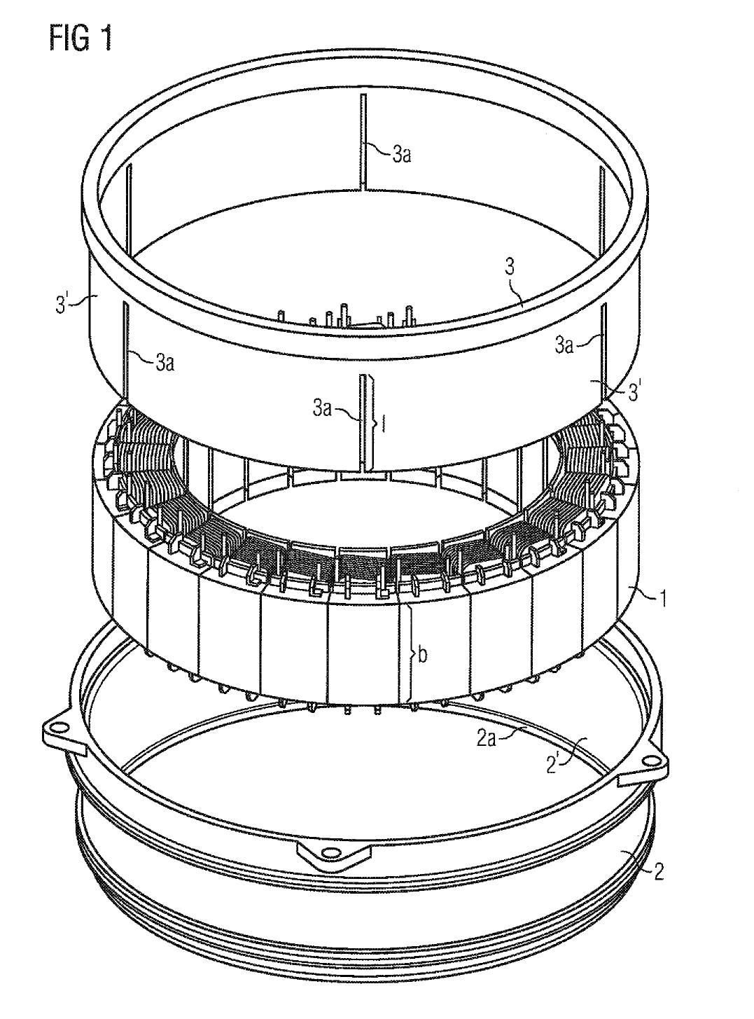

FIG. 1 illustrates the annular segment package 1, the annular housing 2 and the annular sleeve 3 three-dimensionally. In the method for fixing the annular segment package 1 with the cylindrical outer wall in an annular housing 2, whose inner wall 2′ is in the form of an inner cone, the annular segment package 1 is either first of all introduced into the annular housing 2, and then the annular sleeve 3, whose outer wall 3′ is in the form of an outer cone which is designed to be compatible with the inner cone of the annular housing 2, is introduced between the annular segment package 1 and the annular housing 2 and is compressed on both inner and outer circumferential surface, or the annular segment package 1 is first of all introduced into the annular sleeve 3 and is compressed on its outer circumferential surface, and the combination of the annular segment package 1 and the annular sleeve 3 is then introduced into the annular housing 2 and is compressed. In order to make it easier to fix the annular segment package 1 in the annular housing 2 with the aid of the annular sleeve 3, it is particularly advantageous to use an annular sleeve 3 which, starting from the outer edge with the smallest external diameter of the outer cone, has longitudinal slots 3a which are arranged alongside one another parallel to the longitudinal axis of the annular sleeve 3 and whose respective length l is less than the width of the annular sleeve 3. A length l of the respective longitudinal slots 3a is particularly advantageously chosen to be greater than the width b of the annular segment package 1. The arrangement of the annular sleeve 3 in the annular housing 2 is simplified in a particularly advantageous manner by the annular sleeve 3 being arranged with the outer edge with the smallest external diameter of the outer cone resting on a stop 2a, in the state in which it is compressed in the annular housing 2. For practical reasons, the stop 2a is part of the annular housing 2. In this case, an annular stator laminated core of an electric motor (not illustrated) is arranged as the annular segment package 1, and a stator housing of an electric motor is arranged as the annular housing 2. The method is particularly advantageous for the purpose according to which the use of an electric motor for a hybrid car (not illustrated) is envisaged.

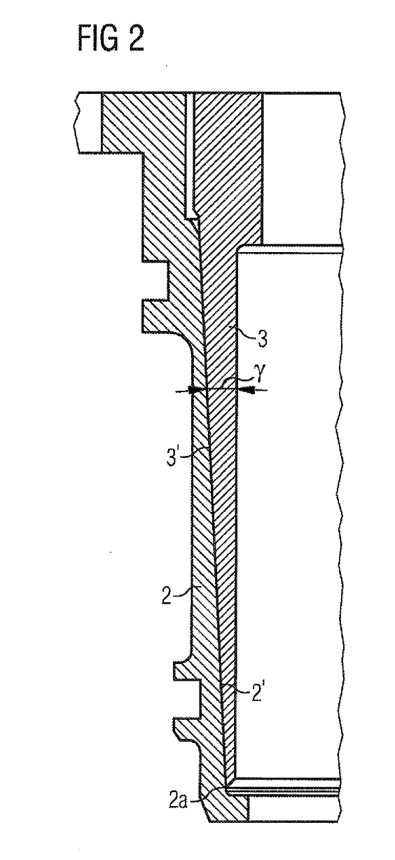

FIG. 2 is a longitudinal section of the annular housing 2 and the annular sleeve 3 in the compressed state For clarity this illustration does not show the annular segment package 1 with the cylindrical outer wall. The annular sleeve 3 is arranged in the annular housing 2 such that it rests with the outer edge with the smallest external diameter of the outer cone on a stop 2a which is part of the annular housing 2. In this case, in general, a common angle γ for the inner cone and for the outer cone is chosen in the range from 2 to 5°. The configuration of the outer wall 3′ in the form of an outer cone, which is designed to be compatible with the inner cone of the annular housing 2 allows, by virtue of engineering design, fixed compression of the annular sleeve 3 with the annular housing 2. The inner wall 2′ of the annular housing 2 and the outer wall 3′ of the annular sleeve 3 are in this way firmly connected to one another, or compressed, with a force fit.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-7. (canceled)

8. A method for fixing an annular segment package with a cylindrical outer wall in an annular housing having a conical inner wall, comprising:
inserting the annular segment package into the annular housing; and
inserting, between the annular segment package and the annular housing, an annular sleeve having an outer conical wall that is configured to mate with the conical inner wall of the annular housing and retain the annular segment package,
whereby the annular sleeve is compressed about its outer circumference due to the mating conical walls.

9. The method as claimed in claim 8, wherein a common angle γ for the inner conical wall and for the outer cone is in the range from 2° to 5°.

10. The method as claimed in claim 8, wherein the annular sleeve comprises a plurality of longitudinal slots beginning from the outer edge of the outer conical wall with the smallest external diameter arranged alongside one another and substantially parallel to a longitudinal axis of the annular sleeve,
wherein a length of each of the plural longitudinal slots is less than a longitudinal width of the annular sleeve.

11. The method as claimed in claim 10, wherein the longitudinal slot length of the longitudinal slots is greater than a longitudinal width of the annular segment package.

12. The method as claimed in claim 10, wherein in a state that the annular sleeve is compressed in the annular housing, the annular sleeve is arranged with the smallest external diameter of the outer cone resting on a stop.

13. The method as claimed in one of claim 8, wherein an annular stator laminated core of an electric motor is arranged as the annular segment package, and a stator housing of an electric motor is arranged as the annular housing.

14. The method as claimed in claim 13, wherein an electric motor for a hybrid car is used as the electric motor.

15. The method as claimed in claim 9, wherein an annular sleeve is used which, starting from the outer edge with the smallest external diameter of the outer cone, has a plurality of longitudinal slots arranged alongside one another parallel to the longitudinal axis of the annular sleeve each having a respective length less than a longitudinal width of the annular sleeve.

16. The method as claimed in one of claim 11, wherein in a state in which the annular sleeve is compressed in the annular housing, the annular sleeve is arranged with the smallest external diameter of the outer cone resting on a stop.

17. A method for fixing an annular segment package with a cylindrical outer wall in an annular housing, whose inner wall is in the form of an inner cone, comprising:
inserting the annular segment package into the annular sleeve having an outer cone;
inserting the annular sleeve together with the annular segment package into the annular housing; and
compressing a circumference of the annular sleeve,
whereby the annular segment package is fixed in the annular housing.

18. The method as claimed in claim 17, wherein a common angle γ for the inner cone and for the outer cone is chosen in the range from 2 to 5°.

19. The method as claimed in claim 17, wherein the annular sleeve comprises longitudinal slots beginning from the outer edge of the outer conical wall with the smallest external diameter arranged alongside one another and substantially parallel to a longitudinal axis of the annular sleeve,
wherein a length of the longitudinal slots is less than a longitudinal width of the annular sleeve.

20. The method as claimed in claim 19, wherein the slot length of the longitudinal slots is greater than a longitudinal width of the annular segment package.

21. The method as claimed in one of claim 19, wherein in a state that the annular sleeve is compressed in the annular housing, the annular sleeve is arranged with the smallest external diameter of the outer cone resting on a stop.

22. The method as claimed in one of claim 17, wherein an annular stator laminated core of an electric motor is arranged as the annular segment package, and a stator housing of an electric motor is arranged as the annular housing.

23. The method as claimed in claim 22, wherein an electric motor for a hybrid car is used as the electric motor.

24. The method as claimed in claim 18, wherein an annular sleeve is used which, starting from the outer edge with the smallest external diameter of the outer cone, has longitudinal slots arranged alongside one another parallel to the longitudinal axis of the annular sleeve and whose respective length is less than a longitudinal width of the annular sleeve.

25. The method as claimed in one of claim 20, wherein in a state in which the annular sleeve is compressed in the annular housing, the annular sleeve is arranged with the smallest external diameter of the outer cone resting on a stop.
